(19) United States
(12) Patent Application Publication
(10) Pub. No.: US 2015/0064296 A1
(43) Pub. Date: Mar. 5, 2015

(54) ANNULAR CO-EXTRUSION DIE

(71) Applicant: Macro Engineering & Technology Inc., Mississauga (CA)

(72) Inventor: Miroslav Planeta, Mississauga (CA)

(73) Assignee: Macro Engineering & Technology Inc., Mississauga (CA)

(21) Appl. No.: 14/017,420

(22) Filed: Sep. 4, 2013

(51) Int. Cl. B29C 47/06; B32B 37/00

(52) U.S. Cl. CPC B29C 47/06; B32B 37/0046; B29D 23/00
USPC 425/133.1

(57) ABSTRACT

An annular co-extrusion die for extruding multi-layer tubular plastic film has inner die mandrels stacked one upon another. Each die mandrel has a generally U-shaped cross-section with side walls extending substantially in parallel with the longitudinal axis of the die. The outer surfaces of the die side walls each have a series of helical shaped grooves formed therein. An annular outer die member surrounds the first inner die mandrel and the inner surface of the outer member and the outer surface of the first inner die mandrel form a longitudinally extending annular extrusion passage. Additional longitudinally extending annular extrusion passages are formed between outer and inner surfaces of nesting inner die mandrels.

### TECHNICAL FIELD

The present disclosure relates to annular co-extrusion dies for extruding a multi-layer tubular plastic film.

### BACKGROUND

Annular co-extrusion dies have been known for many years. Conventional dies of this kind usually have a series of concentric radially spaced annular die members of different diameters which define concentric radially spaced annular passages for separately feeding different plastic materials to a common annular passage such that a multi-layer tubular plastic film is extruded therefrom. In such annular co-extrusion dies, the radially spaced annular passages are fed either from a central feed block or through side passages, each of which increases the cost and complexity of the die.

In recent years, multi-layer co-extrusion dies have been made with die members stacked one above the other to form annular feed passages for the different plastic materials. Such dies have advantages over the conventional concentric radially spaced die member design in that they can be more easily modified to vary the number of layers. Also, the temperature of the different plastic materials can be better controlled. One example of such a multi-layer co-extrusion die is U.S. Pat. No. 5,690,972 to Planeta et al. While such multi-layer co-extrusion dies are well suited to certain applications, they are less well suited to applications requiring a large number of layers. As the height increases with the number of layers, the plastic material which flows through the annular passages formed by lower die members in the stack has to travel longer distances than the plastic material which flows through annular passages formed by higher die members in the stack. This can cause problems in obtaining a satisfactory multi-layer tubular plastic film with a large number of layers.

The conventional concentric radially spaced die member design described above has each of the die members providing plastic material to a shared annular passage at different positions. This results in some of the layers flowing separately before combining with other layers and can result in instability of the extruded multilayer material.

U.S. Pat. No. 7,097,441 to Sagar et al., the entirety of which is hereby incorporated by reference, illustrates annular co-extrusion dies having frusto-conical die members that are stacked one upon another in a nested configuration. This design is versatile because the dies are easy to take apart and clean and also have a relatively low wetted surface area compared to other dies of a similar size. This design has a shared annular extrusion passage that is formed between the outer surfaces of the side walls of the frusto-conical mandrels and the inner surface of the outer die body member (or members). The Sagar et al. patent also teaches an innovative feed mechanism in which opposed grooves in the upper and lower surfaces of adjacent mandrels form some of the feed channels.

Although the annular co-extrusion die taught by Sagar et al. is well-suited to applications in which the die diameter is greater than about 400 mm, adapting the annular co-extrusion die taught by Sagar et al. to smaller die diameters is difficult because the small diameter of the lowermost mandrel leaves little room for feed channels and the air passage(s). Although this difficulty can be surmounted when the number of layers (and hence the number of mandrels) is small, as the number of layers increases, more mandrels are required which in turn require a larger number of feed passages to pass through the lowermost mandrel.

### SUMMARY

The present disclosure improves upon the annular co-extrusion die taught by Sagar et al. by replacing the nested frusto-conical mandrels, whose walls extend radially outwardly as well as upwardly, with nested mandrels whose side walls, and the helical passages formed thereby, extend upwardly substantially parallel to the longitudinal axis of the die. The feed passage structure of the annular co-extrusion die taught by Sagar et al. is retained. The structure described in the present disclosure provides more room in the lowermost mandrel for feed channels and air passages than the annular co-extrusion die taught by Sagar et al. for a die of equal die diameter.

Accordingly, there is provided an annular co-extrusion die for extruding multi-layer tubular plastic film, the annular co-extrusion die having a longitudinal axis, the die comprising a lower outer die member having an annular outer die body member. A first inner die mandrel is attached to the lower outer die member. The first inner die mandrel has a base portion with a side wall extending upwardly therefrom substantially parallel with the longitudinal axis of the die, and the outer surface of the side wall has a series of helical grooves that form upwardly extending helical passages coupled to a first longitudinally extending annular extrusion passage formed between an inner surface of the annular outer die body member and the outer surface of the side wall of the first inner die mandrel. The helical passages are coupled to a first feed passage in the lower outer die member to convey plastic material to the helical passages. A second inner die mandrel is nested within the first inner die mandrel. The second inner die mandrel has a base portion with a side wall extending upwardly therefrom substantially parallel with the longitudinal axis of the die. The outer surface of the side wall of the second inner die mandrel having a series of helical grooves that form upwardly extending helical passages coupled to a second longitudinally extending annular extrusion passage formed between an inner surface of the first inner die mandrel and the outer surface of the side wall of the second inner die mandrel. The helical passages of the second inner die mandrel are coupled to a second feed passage in the lower outer die member to convey plastic material to the helical passages of the second inner die mandrel. The first and second inner die mandrels can have a U-shaped cross-section that facilitates nesting.

The annular co-extrusion die can also have an inner annular die lip member and an outer annular die lip member that cooperate to form a common annular extrusion passage that joins the first and second annular extrusion passages. The inner annular die lip member and outer annular die lip member can also define an annular extrusion orifice for extruding the material from the common annular extrusion passage. The outer annular die lip member can be attached to the annular outer die body member and the inner annular die lip member can be attached to an innermost nested inner die mandrel.

The first feed passage can have a vertical feed passage portion that communicates with a vertical feed passage in the base portion of the first inner die mandrel. The vertical feed passage can be coupled to a series of transverse feed passages extending radially outward within the base portion of the first inner die mandrel, with the transverse feed passages coupled to the helical grooves of the first inner die mandrel. The vertical feed passage portion can be coupled to the vertical feed passage by a horizontal feed passage. The horizontal feed passage can be formed as a groove in any one of a lower surface of the first inner die mandrel, an upper surface of the lower outer die member, and both the lower surface of the first inner die mandrel and the upper surface of the lower outer die member.

The second feed passage can have a vertical feed passage portion that communicates with a vertical feed passage in the base portion of the second inner die mandrel, the vertical feed passage coupled to a series of transverse feed passages extending radially outward within the base portion of the second inner die mandrel, the transverse feed passage coupled to the series of helical passages of the second inner die mandrel.

The annular co-extrusion die can include a third inner die mandrel nested within the second inner die mandrel. The third inner die mandrel can have a base portion with a side wall extending upwardly therefrom substantially parallel with the longitudinal axis of the die. An outer surface of the side wall of the third inner die mandrel has a series of helical grooves that form upwardly extending helical passages coupled to a third longitudinally extending annular extrusion passage formed between an inner surface of the second inner die mandrel and the outer surface of the side wall of the third inner die mandrel. The helical passages of the third inner die mandrel can be coupled to a third feed passage in the lower outer die member to convey plastic material to the helical passages of the second inner die mandrel.

The common annular extrusion passage can combine the first, second and third annular extrusion passages.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 is a perspective cut-away view of a cross-section of an embodiment of an annular co-extrusion die having stacked die mandrels;

FIG. 2 is a top plan view of an embodiment of an annular co-extrusion die having stacked die mandrels;

FIG. 3 is a sectional view taken along line A-A of FIG. 2;

FIG. 4 is a partial sectional view showing a first variation of inner and outer annular die lip members; and

FIG. 5 is a partial sectional view showing a second variation of inner and outer annular die lip members.

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without some of these specific details. In other instances, well-known methods, procedures and components have not been described in detail so as not to obscure the embodiments described herein. Furthermore, this description is not to be considered as limiting the scope of the embodiments described herein, or of the appended claims, in any way, but rather to serve as a guide to a person skilled in the art for achieving at least some of the advantages of various embodiments described herein.

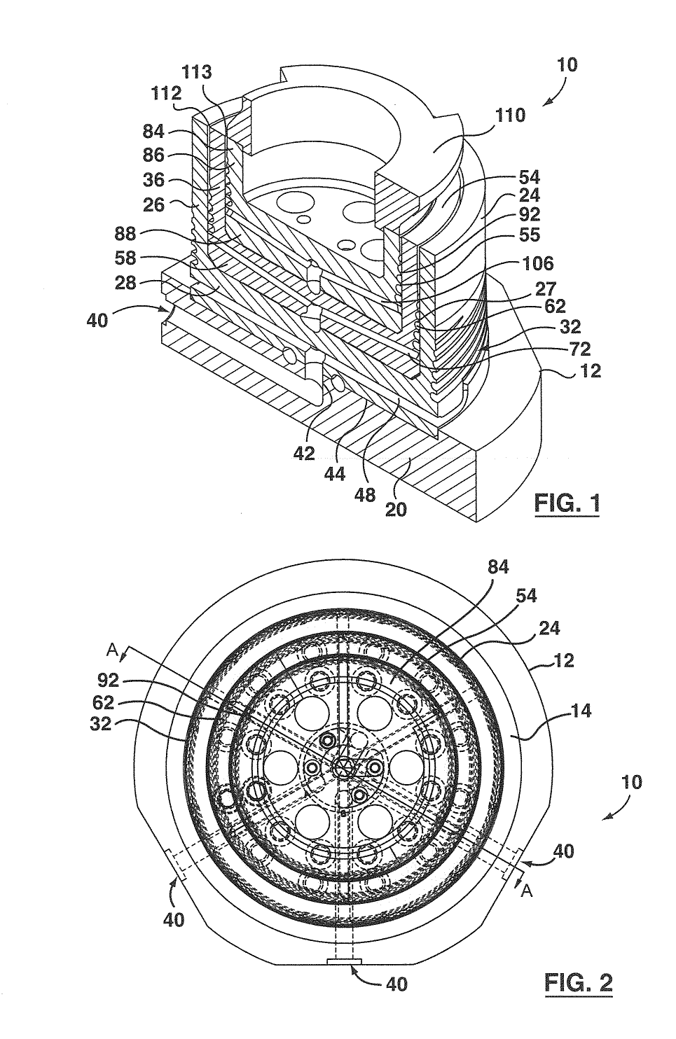

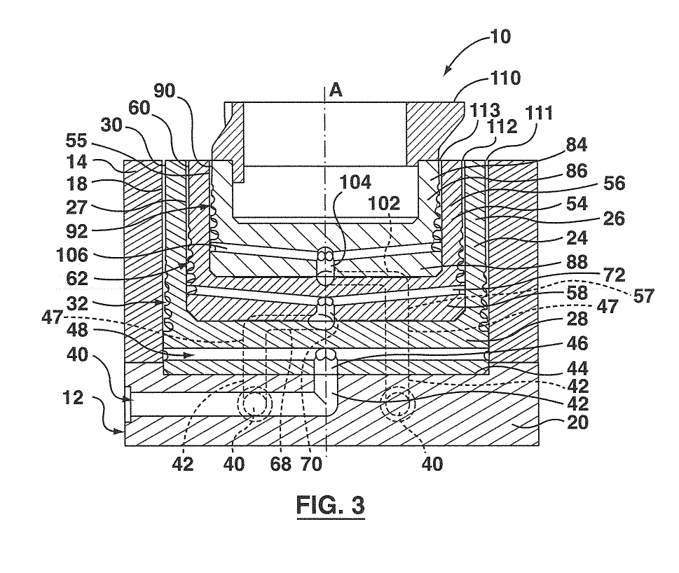

Referring first to FIGS. 1 to 3, an annular co-extrusion die 10 is shown having a lower outer die member 12 with a first inner die mandrel 24 secured thereto via circumferentially spaced bolts (not shown). A second inner die mandrel 54 having a similar shape to the first inner die mandrel 24 is mounted on top of and nested within the first inner die mandrel 24 in a stacked relationship. A third inner die mandrel 84, also similarly shaped to the first and second die mandrels 24, 54, is similarly mounted on top of and nested within second die mandrel 54 in a stacked relationship. Annular extrusion passages 111, 112 and 113 (FIG. 3) are formed between the outer die member 12 and the first inner mandrel 24 as well as between adjacent inner die mandrels. Other embodiments can vary the number of inner die mandrels in order to vary the number of annular extrusion passages, and thus the number of layers of the extruded multilayer film.

The lower outer die member 12 can comprise an annular outer die body member 14 that can be integral with a base portion 20 of the lower outer die member 12 (see FIG. 5, for example) or attached to the base portion 20 of the lower outer die member 12 using bolts. The first inner die mandrel 24 has a base portion 28 and an upwardly extending side wall 26. The first inner die mandrel 24 has a generally U-shaped cross-section, with the upwardly extending side wall 26 extending substantially perpendicularly from the base portion 28 and substantially parallel to the longitudinal axis A (FIG. 3) of the annular co-extrusion die 10. An outer surface 30 of the side wall 26 has a series of helical grooves 32 which co-operate with an inner surface 18 of an annular outer die body member 14 to form upwardly extending helical passages therebetween. The helical passages are in communication with the annular extrusion passage 111 between the outer die member 12 and first inner mandrel 24. The inner surface 18 of the annular outer die body member 14 is also substantially parallel to the longitudinal axis A so that the upwardly extending helical passages also extend in a direction parallel to the longitudinal axis A. The helical grooves 32 have multiple starts (not shown), in the same manner as shown in FIG. 2 of U.S. Pat. No. 5,690,792, which is hereby incorporated by reference.

The base portion 20 of the lower outer die member 12 has a circumferentially extending series of feed passages 40 extending radially inwardly from the exterior of the base portion 20. At its inner end, each feed passage 40 has a 90 degree bend to a vertical feed passage portion 42 which opens onto the upper surface 44 of the base portion 20. One of the vertical feed passage portions 42 can be located at the radial centre of the base portion 20, i.e. located on the longitudinal axis A of the die 10.

Referring in particular to FIG. 3, the first inner die mandrel 24 has a short vertical feed passage 46 extending upwardly for a short distance from its lower surface and aligned with the vertical feed passage portion 42 of the corresponding feed passage 40. The base portion 28 of the first inner die mandrel 24 has a circumferentially extending series of transverse feed passages 48 extending in a radially outward direction from the upper end of the vertical feed passage 46. The transverse feed passages 48 extend to the lower end of the helical grooves 32. The base portion 28 of the mandrel 24 is bolted to the base portion 20 of the lower outer die member 12 by circumferentially spaced bolts (not shown).

In some embodiments, the vertical feed passage portion 42 can be coupled to the vertical feed passage 46 by a horizontal feed passage. In such an embodiment, at its radially outer end, the horizontal feed passage communicates with the top of the vertical feed passage portion 42, and at the longitudinal axis A the horizontal feed passage communicates with the vertical feed passage 46. The horizontal feed passage can be formed between complementary grooves in the upper surface 44 of base portion 20 and in the lower surface of first inner die mandrel 24. Alternatively, the horizontal feed passage can be formed by a groove in either the upper surface of base portion 20 or the lower surface of first inner die mandrel 24.

The base portion 28 of first inner die mandrel 24 also has two circumferentially spaced vertical feed passages 47 extending from the bottom to the top thereof and radially spaced from the longitudinal axis A of the die 10. As will be explained further below, the two circumferentially spaced vertical feed passages 47 connect with respective vertical feed passages 70, 104 in the nested second and third inner die mandrels 54, 84.

The second inner die mandrel 54 is similarly shaped to the first inner die mandrel 24 to allow the second inner die mandrel 54 to be mounted on top of the lower mandrel 24 and nested therein, i.e. in stacking relationship therewith. The second inner die mandrel 54 has a base portion 58 and a side wall 56 extending upwardly therefrom. The second inner die mandrel 54, similarly to the first inner die mandrel, has a generally U-shaped cross-section with the side wall 56 extending substantially perpendicularly from the base portion 58 and substantially parallel to the longitudinal axis A of annular co-extrusion die 10. An outer surface 60 of the side wall 56 has a series of helical grooves 62 which co-operate with an inner surface 27 of the first inner die mandrel 24 to form upwardly extending helical passages therebetween. The inner surface 27 of the first inner die mandrel 24 is also substantially parallel to the longitudinal axis A so that the upwardly extending helical passages between the inner surface 27 and the outer surface 60 of the side wall 56 also extend in a direction parallel to the longitudinal axis A. As before, the helical grooves 62 have multiple starts (not shown) at their lower ends.

Continuing to refer to FIG. 3, the vertical feed passage portion 42 of one of the feed passages 40 is in communication with one of the vertical feed passages 47 in the base portion 28 of the first mandrel 24. This allows material to be fed from feed passage 40 in the lower outer die member 12 through the base portion 28 of the first inner mandrel 24 to feed material to the helical grooves 62 of the second inner die mandrel 54. In the illustrated embodiment, the second inner die mandrel 54 has a short vertical feed passage 70 that extends upwardly for a short distance from a lower surface of the base portion 58 and communicates with the corresponding vertical feed passage 47 that passes through first inner die mandrel 54. The base portion 58 of the second inner die mandrel 54 has a circumferentially extending series of transverse feed passages 72 extending radially outwardly from the upper end of the vertical feed passage 70 to the lower end of the helical grooves 62. The second inner die mandrel 54 is bolted to the first inner die mandrel 24 by circumferentially spaced bolts (not shown).

The vertical feed passage 47 in the base portion 28 of the inner die mandrel 24 that communicates with the vertical feed passage 70 in the nested second mandrel 54 does so via a horizontal feed passage 68. At its radially outer end, the horizontal feed passage 68 communicates with the top of the vertical feed passage 47, and at the longitudinal axis A the horizontal feed passage 68 communicates with the vertical feed passage 70. The horizontal feed passage 68 can be formed between complementary grooves in the upper surface of the first inner die mandrel 24 and in the lower surface of the second inner die mandrel 54. Alternatively, the horizontal feed passage 68 can be formed by a groove in either the upper surface of the first inner die mandrel 24 or the lower surface of the second inner die mandrel 54.

Still referring to FIG. 3, the second vertical feed passage 47 in the base portion 28 of the inner die mandrel 24 communicates with a vertical feed passage 57 in the base portion 58 of the second inner die mandrel 54. This vertical feed passage 57 extends from the bottom to the top of the second inner die mandrel 54, radially spaced from the longitudinal axis A of the die 10. The vertical feed passage 57 communicates with a short vertical feed passage 104 in nested third inner die mandrel 84 as explained further below.

The third inner die mandrel 84 is similarly shaped to the first and second inner die mandrels 24, 54 to allow the third inner die mandrel 84 to be mounted on top of the lower mandrel 54 and nested therein, i.e. in stacking relationship therewith. The third inner die mandrel 84 has a base portion 88 and a side wall 86 extending upwardly therefrom. The third inner die mandrel 84, similar to the first and second inner die mandrels 24, 54, has a generally U-shaped cross-section with the side wall 86 extending substantially perpendicularly from the base portion 88 and substantially parallel to the longitudinal axis A of the annular co-extrusion die 10. An outer surface 90 of the side wall 86 has a series of helical grooves 92 which co-operate with an inner surface 55 of second inner die mandrel 54 to form upwardly extending helical passages therebetween. The inner surface 55 of the second inner die mandrel 54 is also substantially parallel to the longitudinal axis A so that the upwardly extending helical passages between the inner surface 55 and the outer surface 90 of the side wall 86 also extend in a direction parallel to longitudinal axis A. As before, the helical grooves 92 have multiple starts (not shown) at their lower ends.

As shown in FIG. 3, the vertical feed passage portion 42 of one of the feed passages 40 is radially spaced from the longitudinal axis A of the die 10, and communicates with a vertical feed passage 47 in the base portion 28 of the first inner die mandrel 24 and a vertical feed passage 57 in the base portion 58 of the second inner die mandrel 54. This allows material to be fed from the feed passage 40 in the lower outer die 12 through the first inner die mandrel 24 and the second inner die mandrel 54 to feed material to the helical grooves 92 of third inner die mandrel 84. In the illustrated embodiment, the third inner die mandrel 84 has a short vertical feed passage 104 that extends upwardly for a short distance from a lower surface of the base portion 88 and communicates with the corresponding feed passages 47 and 57 through the first and second inner die mandrels 54, 84, respectively. The base portion 88 of the third inner die mandrel 84 has a circumferentially extending series of transverse feed passages 106 extending radially outwardly from the upper end of the vertical feed passage 104. The transverse feed passages 106 extend to the lower end of the helical grooves 92. The third inner die mandrel 84 is bolted to the second inner die mandrel 54 by circumferentially spaced bolts (not shown).

The vertical feed passage 57 is coupled to the vertical feed passage 104 by a horizontal feed passage 102 as shown in FIG. 3. At its radially outer end, the horizontal feed passage 102 communicates with the top of the vertical feed passage 57, and at the longitudinal axis A the horizontal feed passage 102 communicates with the vertical feed passage 104. The horizontal feed passage 102 can be formed between complementary grooves in the upper surface of the second inner die mandrel 54 and in the lower surface of the third inner die mandrel 84. Alternatively, the horizontal feed passage 102 can be formed by a groove in either the upper surface of the second inner die mandrel 54 or the lower surface of the third inner die mandrel 84.

The first, second and third inner die mandrels 24, 54, 84 are secured to each other and to the lower outer die member 12 to provide annular extrusion passages 111, 112, 113. The outermost annular extrusion passage 111 is formed between the inner surface 18 of the annular outer die body member 14 and the outer surface 30 of the side wall 26 of the first inner die mandrel 24. The next or intermediate annular extrusion passage 112 is formed between the inner surface 27 of the first inner die mandrel 24 and the outer surface 60 of the side wall 56 of the second inner die mandrel 54. The innermost annular extrusion passage 113 is similarly formed between the inner surface 55 of the second inner die mandrel 54 and the outer surface 90 of the side wall 86 of the third inner die mandrel 84. Each of the annular extrusion passages 111, 112, 113 extends substantially parallel to one another and substantially parallel to the longitudinal axis A.

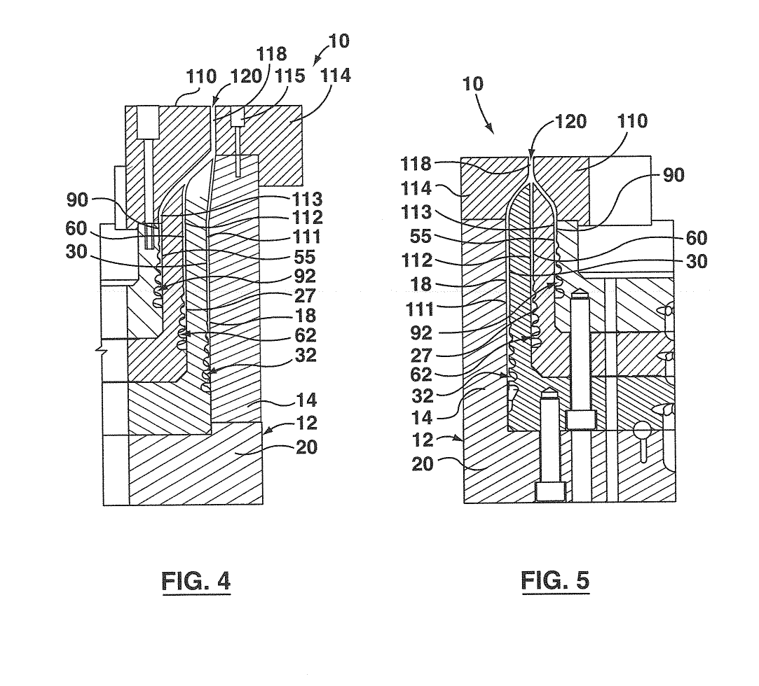

Referring now to FIGS. 4 and 5, in an embodiment the annular extrusion passages 111, 112, 113 extend into a common annular extrusion passage 118 that is formed between an inner annular die lip member 110 and an outer annular die lip member 114. The inner annular die lip member 110 is mounted on top of the third, innermost mandrel 84 and is secured thereto by circumferentially spaced bolts 115 (only one of which is shown in FIG. 4). In some embodiments, the inner annular die lip member 110 can be integral with the third, innermost mandrel 84. The shape of the upper portion of the side walls 26, 56 and the inner and outer annular die lip members 110, 114 define how each of the layers flowing in the annular extrusion passages 111, 112, 113 combine to form multilayer material in the common annular extrusion passage 118 that is then extruded through an annular extrusion orifice 120; different variations are shown in FIGS. 4 and 5. Design of these surfaces provides control of how each layer of the multilayer film is combined.

In operation, different plastic materials are supplied from different extruders through their respective feed passages 40. As shown, one of the feed passages 40 supplies plastic material through the vertical feed passage 46 and the transverse feed passages 48 to the helical grooves 32 so as to extrude a first film layer into the annular extrusion passage 111. Another feed passage 40 feeds another plastic material through one of the vertical feed passages 47, the horizontal passage 68 and the vertical passage 70 to the transverse feed passages 72 and helical grooves 62 to extrude a second film layer into the annular passage 112. A third feed passage 40 feeds yet another plastic material through the vertical feed passages 47, 57, the horizontal feed passage 102 and the vertical feed passage 104 to the transverse passages 106 and helical grooves 92 to extrude a third film layer into the annular extrusion passage 113. Plastic material flowing through annular extrusion passages 111, 112, 113 are joined together in common annular extrusion passage 118 and extruded from annular extrusion orifice 120.

Although the exemplary embodiment is shown with first, second and third inner die mandrels, other embodiments may include only first and second inner die mandrels, or more than three concentrically nested inner die mandrels.

The term “substantially” as used with respect to longitudinal axis A allows for a slight variation of a few degrees off center but is preferably aligned with longitudinal axis A.

The term “integral”, and its derivations, are used herein to indicate a part that is fabricated from a single piece of material. The term “integral” as used herein specifically excludes other means for maintaining parts fixed together as a single unit. More particularly, the term “integral” is used to specifically exclude known variations where a component can be machined as two separate parts that are later attached together using known mechanical or chemical means.

It is to be understood that the disclosed embodiments can be varied by a person skilled in the art while still providing benefits and advantages of the embodiments described herein. Other embodiments and the advantages thereof will be readily apparent to a person skilled in the art, the scope of the claims to be given a full, fair and purposive construction in view of the specification.

1. An annular co-extrusion die for extruding multi-layer tubular plastic film, the annular co-extrusion die having a longitudinal axis, the die comprising:
a lower outer die member having an annular outer die body member;
a first inner die mandrel attached to the lower outer die member, the first inner die mandrel having a base portion with a side wall extending upwardly therefrom substantially parallel with the longitudinal axis of the die, an outer surface of the side wall having a series of helical grooves that form upwardly extending helical passages coupled to a first longitudinally extending annular extrusion passage formed between an inner surface of the annular outer die body member and the outer surface of the side wall, the helical passages coupled to a first feed passage in the lower outer die member to convey plastic material to the helical passages; and
a second inner die mandrel nested within the first inner die mandrel, the second inner die mandrel having a base portion with a side wall extending upwardly therefrom substantially parallel with the longitudinal axis of the die, an outer surface of the side wall of the second inner die mandrel having a series of helical grooves that form upwardly extending helical passages coupled to a second longitudinally extending annular extrusion passage formed between an inner surface of the first inner die mandrel and the outer surface of the side wall of the second inner die mandrel, the helical passages of the second inner die mandrel coupled to a second feed passage in the lower outer die member to convey plastic material to the helical passages of the second inner die mandrel.

2. The annular co-extrusion die of claim 1 further comprising an inner annular die lip member and an outer annular die lip member that cooperate to form a common annular extrusion passage joining the first and second annular extrusion passages.

3. The annular co-extrusion die of claim 2, wherein the inner annular die lip member and outer annular die lip member define an annular extrusion orifice.

4. The annular co-extrusion die of claim 3, wherein the outer annular die lip member is attached to the annular outer die body member.

5. The annular co-extrusion die of claim 3, wherein the inner annular die lip member is attached to an innermost nested inner die mandrel.

6. The annular co-extrusion die of claim 1, wherein the first and second inner die mandrels each have a U-shaped cross-section.

7. The annular co-extrusion die of claim 1, wherein the first feed passage has a vertical feed passage portion that communicates with a vertical feed passage in the base portion of the first inner die mandrel, the vertical feed passage coupled to a series of transverse feed passages extending radially outward within the base portion of the first inner die mandrel, the transverse feed passages coupled to the series of helical grooves of the first inner die mandrel.

8. The annular co-extrusion die of claim 7, wherein the vertical feed passage portion is coupled to the short vertical feed passage by a horizontal feed passage.

9. The annular co-extrusion die of claim 8, wherein the horizontal feed passage is formed as a groove in any one of a lower surface of the first inner die mandrel, an upper surface of the lower outer die member, and both the lower surface of the first inner die mandrel and the upper surface of the lower outer die member.

10. The annular co-extrusion die of claim 7, wherein the second feed passage has a vertical feed passage portion that communicates with a vertical feed passage in the base portion of the second inner die mandrel, the vertical feed passage coupled to a series of transverse feed passages extending radially outward within the base portion of the second inner die mandrel, the transverse feed passages coupled to the series of helical passages of the second inner die mandrel.

11. The annular co-extrusion die of claim 2 further comprising a third inner die mandrel nested within the second inner die mandrel, the third inner die mandrel having a base portion with a side wall extending upwardly therefrom substantially parallel with the longitudinal axis of the die, an outer surface of the side wall of the third inner die mandrel having a series of helical grooves that form upwardly extending helical passages coupled to a third longitudinally extending annular extrusion passage formed between an inner surface of the second inner die mandrel and the outer surface of the side wall of the third inner die mandrel, the helical passages of the third inner die mandrel coupled to a third feed passage in the lower outer die member to convey plastic material to the helical passages of the third inner die mandrel, wherein the common annular extrusion passage combines the first, second and third annular extrusion passages.
